(19) United States
(12) Patent Application Publication
(10) Pub. No.: US 2020/0293846 A1
(43) Pub. Date: Sep. 17, 2020

(54) CODE INCLUDING ADDITIONAL INFORMATION AND METHOD OF GENERATING AND READING THE SAME

(71) Applicant: Ji Un KIM, Yongin-si (KR)

(72) Inventor: Ji Un KIM, Yongin-si (KR)

(21) Appl. No.: 16/799,827

(22) Filed: Feb. 25, 2020

(30) Foreign Application Priority Data
Mar. 15, 2019 (KR) 10-2019-0029889

(51) Int. Cl. G06K 19/06; G06K 7/14

(52) U.S. Cl. CPC G06K 19/06037; G06K 7/1417; G06K 2019/06225; G06K 7/1491; G06K 7/1452

(57) ABSTRACT

Disclosed is a method of generating a code including additional information, including: generating, by an administrator module interworking with a product selling server, a first code including information about a product to be sold by a seller; generating, by the administrator module, a second code including information about a store where the product to be sold by the seller is located and distinguished from the first code; and generating, by the administrator module, a completion code including the product information and the store information of the corresponding product by combining a plurality of codes including the first and second codes, wherein the completion code is configured to have information different from the first and second codes by combining information about a same point of the first and second codes.

### BACKGROUND OF THE INVENTION

### 1. Field of the Invention

The present invention relates to a code including additional information and a method of generating and reading the same.

### 2. Description of the Related Art

It is expected that all the stores that sell goods will change to unmanned stores to reduce labor costs, and the computational and logistics methods that are performed by human beings will become robotized and subject to the artificial intelligence.

Currently, there has been mainly used a system in which a seller uploads price information of a product to a server by using a barcode or QR code, and when a consumer pays for the desired product using an application interworking with the server, the seller provides the product or service to the consumer according to the payment information.

However, in this case, there is a possibility that inconvenience is increased because an application has to be installed separately for each shop visited by the user.

Although barcodes or QR codes are commonly used to identify merchandise, barcodes do not contain information for distinguishing stores. Thus, stores use different reading standards and different servers, so that the stores have to use mutually different applications.

Therefore, in the process of directly scanning a QR code or a barcode through an application by a buyer, the generation and reading are applied in the same manner and there is a need to provide a code having one subject that stores and manages the contents in a server. To this end, it is necessary to prepare a new code to improve the security that may be required in the process in which a buyer directly scans the code to purchase the product.

### SUMMARY OF THE INVENTION

To solve the problems described above, an object of the present invention is to provide a technique of generating a code that can be improved in security by including additional information, specifically, store information through a combination of existing codes.

To achieve the objects described above, according to one aspect of the present invention, there is provided a method of generating a code including additional information, which includes generating, by an administrator module interworking with a product selling server, a first code including information about a product to be sold by a seller; generating, by the administrator module, a second code including information about a store where the product to be sold by the seller is located and distinguished from the first code; and generating, by the administrator module, a completion code including the product information and the store information of the corresponding product by combining a plurality of codes including the first and second codes, wherein the completion code is configured to have information different from the first and second codes by combining information about a same point of the first and second codes.

According to the embodiments of the present invention, because a new code including product information and store information is generated in the process in which a seller receives a product code, information about the generated new code cannot be known from an outside, and the vulnerability of security can be solved even if the user directly scans the code.

### BRIEF DESCRIPTION OF THE DRAWINGS

FIG. 1 is a flowchart illustrating the code usage of a seller and a buyer by a method of generating and reading a code including additional information according to an embodiment of the present invention;

FIG. 2 is a diagram illustrating an example of combining codes including additional information according to an embodiment of the present invention;

FIGS. 3 and 4 are diagrams illustrating a method of combining codes including additional information according to an embodiment of the present invention; and

FIG. 5 is a flowchart specifically illustrating a method of reading a code including additional information according to an embodiment of the present invention.

### DETAILED DESCRIPTION OF THE INVENTION

Hereinafter, embodiments will be described in detail with reference to the accompanying drawings.

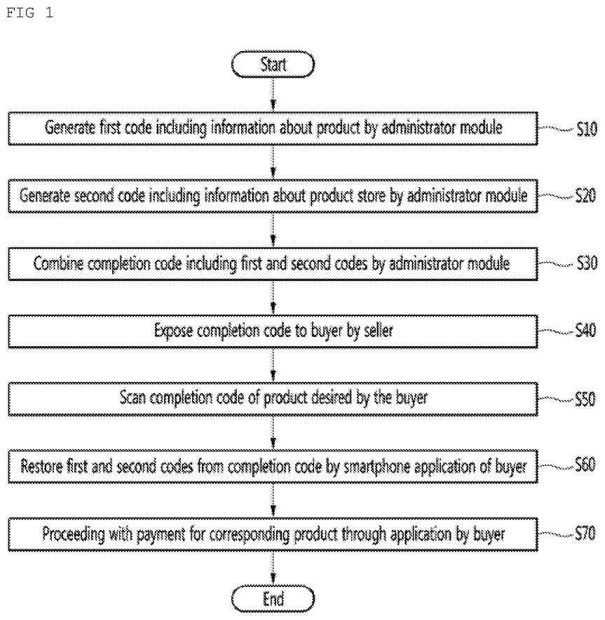

FIG. 1 is a flowchart illustrating the code usage of a seller and a buyer by a method of generating and reading a code including additional information according to an embodiment of the present invention. Referring to FIG. 1, a method may include a step S10 of generating by an administrator module interworking with a product selling server, number 1 code (hereinafter, referred to as a first code) including information about a product to be sold by a seller, a step S20 of generating, by the administrator module, number 2 code (hereinafter, referred to as a second code) including information about a store where the product to be sold by the seller is located, a step S30 of generating, by the administrator module, a completion code including the product information and the store information of the corresponding product by combining a plurality of codes including the first and second codes, and providing the completion code to the seller, a step S40 of exposing, by the seller, the completion code provided from each product to a buyer, a step S50 of scanning, by the buyer, the completion code for the product that the buyer wants to purchase with an application installed on a smartphone, a step S60 of recovering the code including the product information and the code including the information about the store where the product is located by analyzing the completion code through the application, and a step S70 of paying for the product according to a payment unit provided in the application by the buyer.

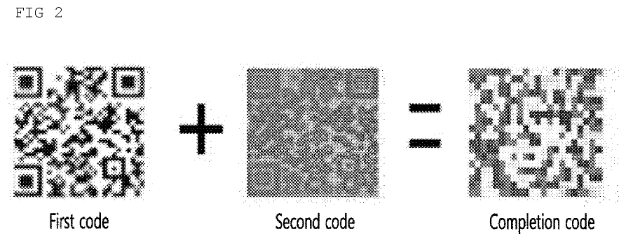

FIG. 2 is a diagram illustrating an example of a combination of codes according to an embodiment of the present invention, and relates to a process performed in steps S10 to S30. The code provided to the seller according to the present invention may be formed by combining at least two codes, and in the embodiment, a case of combining two codes will be described. The above-described code combination may be performed by an administrator module of a product selling server to which the seller subscribes.

The code including additional information according to an embodiment may be formed by combining data on a first code formed to include information about a product by an administrator module of a product selling server and data on a second code formed by the administrator module of the product selling server to include information about a store where the product is located and be distinguished from the first code, where the code is formed to be combined with information about a same point of the first and second codes and have information different from the first and second codes.

Referring to FIG. 2, a code according to an embodiment may include a completion code formed by combining the first and second codes and provided to the seller.

The first code may be a conventional QR code or bar code which has been widely used in the art, or another code may be used as the first code. The first code may be a code indicating information about a product.

The second code may be a code distinguished from the second code, and may include information about a store where a corresponding product is located. The first and second codes may be the same kind of codes, and when the first and second codes are distinguished from each other and of the same standard, the first and second codes may be different kinds of codes. The first and second codes may be distinguished from each other by color. In the embodiment, it is assumed that the first and second codes are QR codes of the same standard.

The completion code may be a code obtained based on the first and second codes that are combined when the first and second codes are overlaid on the same position. The first code including a QR code may be a QR code including white and black therein, and the second code is assumed to be a QR code including blue and red therein such that the first and second codes are distinguished from each other. In this case, the first and second codes should be provided in the same standard.

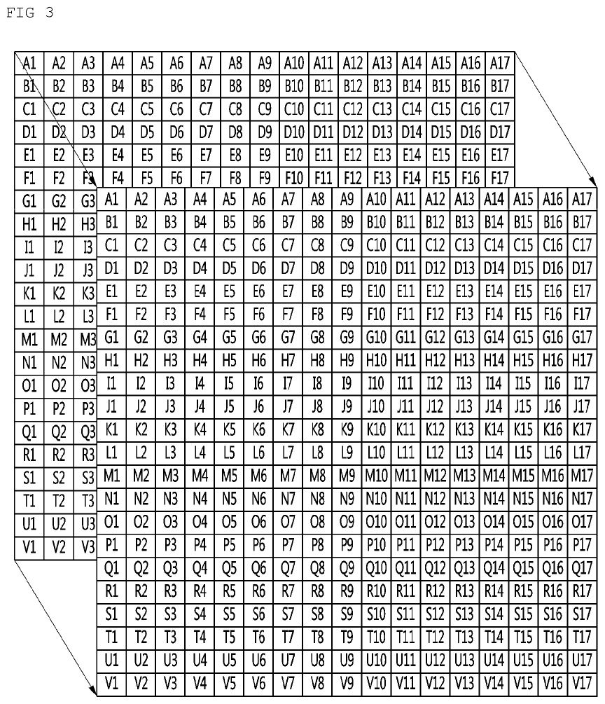

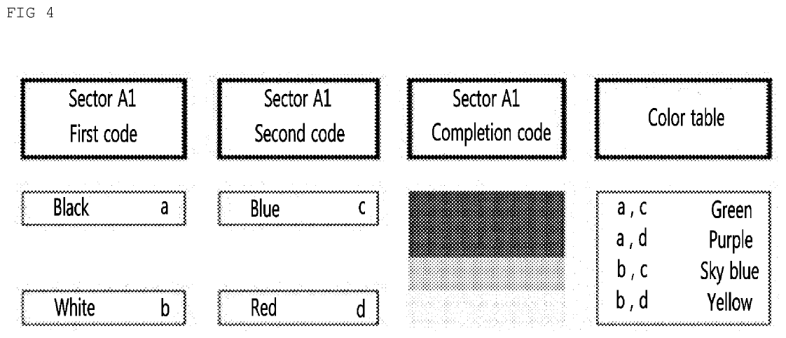

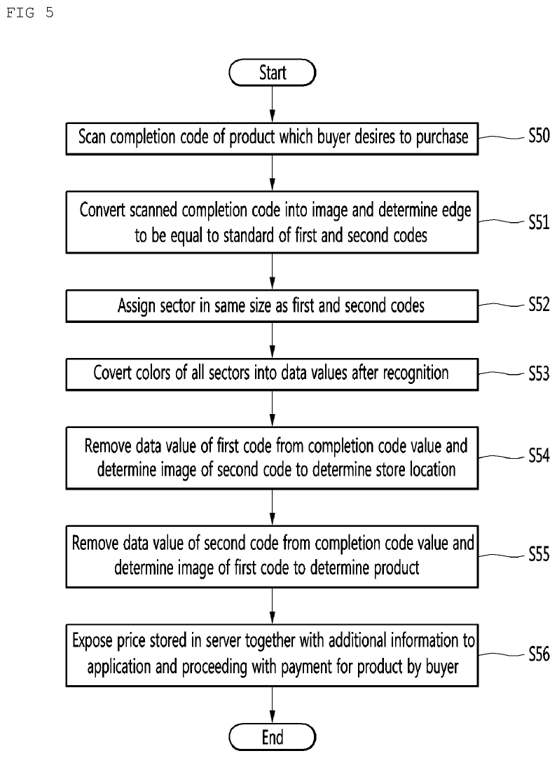

FIGS. 3 and 4 are diagrams illustrating a method of combining codes including additional information according to an embodiment of the present invention. Referring to FIG. 3, the first and second codes of the same standard are divided into pieces in the shape of a checkerboard in a size that are distinguished without damaging the contents thereof. Then, the first and second codes are arranged to overlap at the same position, and each divided position value is displayed in the horizontal and vertical directions to denote the information at the same position of the first and second codes to the completion code.

Referring to FIG. 4, if black is arranged at position A1 of the first code, it is represented by ‘a’ and if white, it is represent by ‘b’. If blue is arranged at position A1 of the second code, it is represented by ‘c’, and if red, it is represented by ‘d’. If white is arranged at position A1 of the first code, the position value of A1 is ‘b’, and if blue is arranged at position A1 of the second code, the position value of A1 is ‘c’.

Thus, if data are collected at a state in which the first and second codes overlap to be overlaid, it is possible to determine the position value of the completion code. Since each of the first and second codes include two colors, a total of four color combinations may be generated, so that color information of (b, c), (b, d), (a, c) and (a, d) may be combined in the completion code.

When black ‘a’ information is included in sector A1 of the first code 1 and blue ‘c’ information is included in sector A1 of the second code, data of (a, c) corresponding to green may be combined in sector A1 of the completion code. When black ‘a’ information is included in sector A1 of the first code 1 and red ‘d’ information is included in sector A1 of the second code, data of (a, d) corresponding to purple may be combined in sector A1 of the completion code. When white ‘b’ information is included in sector A1 of the first code 1 and blue ‘c’ information is included in sector A1 of the second code, data of (b, c) corresponding to sky blue may be combined in sector A1 of the completion code. When white ‘b’ information is included in sector A1 of the first code 1 and red ‘d’ information is included in sector A1 of the second code, data of (b, d) corresponding to yellow may be combined in sector A1 of the completion code.

For example, if sector A1 of the first code is white and sector A1 of the second code is blue, the completion code is a combination of data of (b, c). When the coordinates of (b, c) are searched and matched in a color table, it is confirmed that the color is sky-blue, and the sky blue may be assigned to the position A1 of the completion code.

In this case, it may be assumed that the values of colors that are generated when combining colors assigned to each code are stored in advance in the color table.

That is, by combining the color information corresponding to the same coordinates of the first and second codes with the coordinates of the completion code corresponding to A1, A2, A3 . . . B1, B2, B3 . . . the final color may be assigned and a completion code consisting of four colors may be produced.

The completion code, which is a code made of a combination of the first and second codes, is a new code which is completely different from the first and second codes. The completion code includes the information of the first code and the information of the second code, and may be exposed to the purchaser while hiding the two codes.

Therefore, when the purchaser scans the completion code, because the payment can be made only in the corresponding store, according to the embodiment, it is possible to secure the payment information of the user by using a code into which a plurality of codes are combined. As described above, the completion code, which constitutes information according to the color combination of the first and second codes, may cause a problem of predicting the included code by identifying the number of color combination cases. Thus, in order to further improve security, it is also possible to randomly generate number 3 code (hereinafter, referred to as a third code) for error verification or security while having color information different from the first and second codes, and generate a complete code by combining them.

In the embodiment, a scheme of identifying the first and second codes by color and combining them with each other to generate a completion code has been described as an example, but the embodiment is not limited thereto. It is also possible to identify the first and second codes by color and combine them with each other using figures or symbols in each sector of the complete code.

When a seller inputs the information about a specific product through an administrator page of a server and clicks a button to generate a code, the code generation module of the administrator page generates the first code including the product information and the second code including the store information where the product is placed, and generate the completion code by matching the color table according to the coordinate values of the first and second codes. In addition, the generated completion code is exposed to the administrator page and provided to the seller, so that the seller places the completed code in the store to allow a consumer to use it in various ways.

The above process is to generate a final code and provide it to a seller who sells the product, and may be automatically performed by an algorithm included in the product selling server.

Next, the steps S40 to S70 of FIG. 1 for reading the completed code when the buyer scans the final code displayed in the store to purchase the product will be described. The steps may be performed by an application installed in the smartphone of a buyer and interworking with the product selling server. In the process of FIG. 1, the step S50 of scanning the completion code of the product that a buyer wants to buy may be specifically subdivided as follows.

First, the buyer visits a store and performs a step S50 of scanning the completion code of a desired product with a smartphone application. The completion code scanned by the application is converted into an image, and the step S51 of determining an edge to be the same as the specification of the first and second codes generated by the product selling server. In this case, a plurality of sectors divided into a predetermined size, such as checkboard sizes may be formed.

Next, a step S53 of analyzing the colors disposed in each sector of the completion code and converting the colors of all sectors into data values after recognition may be performed. In this case, the color recognition operation may be matched with data stored in the product selling sever by using a scheme of determining a color. For example, the colors arranged in each sector may be grasped in such a scheme as the color picker of Photoshop®. When the color analysis is completed, the colors in each sector may be converted into data such as (b, c), which is information stored in the product selling server. Each sector of the completion code may be matched with such data.

Then, a step S54 of removing a component corresponding the first code from the value of the color matched to the completion code and determining the image of the second code to determine the location of a store is performed. For example, when (b) is removed from the information about (b, c), only the value of the second code remains in the data of the completion code, so that only the information about (c) remains. When the above-described process is performed for all sectors of the completion code, the image of the second code may be completed, and the location of the store representing the same code may be determined based on the information about the completed second code. The second code is a code including information about a store location, where the information may interwork with the application stored in the product selling server to be linked with an application.

Then, a step S55 of removing a component corresponding to the second code from the value of the color matched to the completion code and determining the image of the first code to determine the product is performed. For example, when (c) is removed from the information of (b, c), only the value of the first code remains in the data on the completion code, so that only information about (b) remains. When the above-described process is performed for all sectors of the completion code, the image of the first code may be completed, and it is possible to determine the product representing the same code based on the information about the completed first code. The first code is a code including product information, and the information may be stored in the product selling server interworking with the application.

Therefore, the store and the product of the completion code scanned by the user may be determined through the database interworking with the administrator page of the product selling server.

Then, a step S56 of exposing the additional information such as a price and the like interworking with the product selling server together with the application of the buyer and thus, paying for the product by the buyer may be performed.

The information about the store name and the product may be exposed through the application of the buyer, and the buyer may purchase the product by making a payment through a payment unit registered in the application as necessary.

According to the code including addition information and the method of generating and reading the same of the embodiment, because a new code including product information and store information is generated in the process, in which a seller receives a product code, so that the information about the generated new code cannot be known from an outside, the vulnerability of security can be solved even if the user directly scans the code. When a buyer makes a payment with a new code, the buyer may go through the process of restoring the information of the product and the location of the store, thereby increasing the creditability of the payment using the code.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of generating a code including additional information, the method comprising:
generating, by an administrator module interworking with a product selling server, a first code including information about a product to be sold by a seller;
generating, by the administrator module, a second code including information about a store where the product to be sold by the seller is located and distinguished from the first code; and
generating, by the administrator module, a completion code including the product information and the store information of the corresponding product by combining a plurality of codes including the first and second codes,
wherein the completion code is configured to have information different from the first and second codes by combining information about a same point of the first and second codes.

2. The method of claim 1, wherein the generating of the completion code by the administrator module includes combining information about colors of the first and second codes to generate the completion code when the first and second codes including QR codes having a same standard overlap to be overlaid with each other at a same location.

3. The method of claim 2, wherein the first and second codes are divided into a plurality of sectors having a specified size, and the completion code is combined with color information corresponding to a sector disposed at a same position as the first and second codes.

4. The method of claim 3, wherein the completion code is pre-stored in the administrator module when the color information of the first and second codes is combined, and a value of a color that is generable when combining colors assigned to each code is matched with a previously stored color table to change to a corresponding color.

5. A code including additional information, the code comprising:
data on a first code formed to include information about a product by an administrator module of a product selling server, and data on a second code, which is distinguished from the first code, formed by the administrator module of the product selling server to include information about a store where the product is located, wherein the data on the first and second codes are combined, and
wherein the code is configured to have information different from the first and second codes by combining information about a same point of the first and second codes.

6. A method of reading a code including additional information, wherein the code includes data on a first code formed to include information about a product by an administrator module of a product selling server, and data on a second code, which is distinguished from the first code, formed by the administrator module of the product selling server to include information about a store where the product is located, and the data on the first and second codes are combined, the method comprising:
scanning, by a purchaser, a completion code of a product to be purchased using an application, and
extracting, by the application of the purchaser, the additional information included in the completion code by decoding the first and second codes in the completion code.

7. The method of claim 6, wherein the decoding of the first and second codes by the application of the purchaser includes
converting the scanned completion code into an image and determining an edge to be identical to a standard of the first and second codes.

8. The method of claim 7, further comprising:
after the converting of the scanned completion code into the image and the determining of the edge to be identical to the standard of the first and second codes, converting the completion code into a data value after assigning sectors having a same size to the first and second codes and recognizing colors of all sectors.

9. The method of claim 8, further comprising:
after the converting of the completion code into the data value, removing the data on the first code from a completion data value and determining a location of the store by determining an image of the second code.

10. The method of claim 8, further comprising:
after the converting of the completion code into the data value, removing the data on the second code from a completion data value and determining an image of the first code to determine the product.
